(19) United States
(12) Patent Application Publication
(10) Pub. No.: US 2011/0019243 A1
(43) Pub. Date: Jan. 27, 2011

(54) STEREOSCOPIC FORM READER

(76) Inventors: Henry J. Constant, JR., West Warwick, RI (US); Steven A. Bozzi, Narragansett, RI (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/506,709

(22) Filed: Jul. 21, 2009

(51) Int. Cl. H04N 1/40

(52) U.S. Cl. 358/448

(57) ABSTRACT

A stereoscopic optical reader of a form example is provided where two images are captured of the same scene on a known form example taken from two different angles. The stereoscopic images are amenable to parallax calculations that may help determine that the form example is flat. If the two captured images are congruent with each other and/or with a stored digital model of the form, the entire form example may be read. If the images are not congruent, the form may be rejected as not being flat, and/or the image data may be further processed via parallax operations and/or other such projections to yield a virtual flat form.

### BACKGROUND OF THE INVENTION

1. Field of the Invention

The present invention relates to reading forms, and more particularly to optically reading forms, converting the optical information into digital data, and storing that digital data for processing.

2. Background Information

Printed documents, play slips, lottery scratch tickets, instant tickets and the like are collectively defined herein as “forms.” Often forms have man made-marks at locations indicating a specific human intent. Correctly identifying a form and reading or processing the printed and man-made markings are important non-trivial tasks.

Some of these tasks include: detecting the presence of a form, determining that the form is motionless, locating and identifying marks on the form, and then interpreting the meaning of the marks.

Forms may be identified by printed markings that are read and interpreted, or a human may indicate the form type. The printed markings normally include logos or other special marks. For example, registration marks may be printed and used by processing equipment to accurately identify the type of form and locations on the form. Herein “registration” is defined to include alignment, orientation, scaling and any other operations performed on an image of a form wherein the individual pixels in the image of a form may be directly compared to pixels in other images or a model image of the same form type. Herein “model” refers to the stored digital image of a particular flat form.

Typically, reading an example of a form begins with a photo-sensitive device or camera or the like capturing an image of the form. The captured image may be digitized, downloaded, stored and analyzed by a computing system running a software application, firmware embedded in a hardware framework, a hardware state machine, or combinations thereof as known to those skilled in the art.

Some form reading systems include an open platen upon which a form is simply laid. The side where the form is inserted may be open, but access to the platen may be open on three or even all four sides. Other types of readers include tractor-type readers that deliver the form to a controlled environment for reading.

One continuing problem with form readers is that if the form is not flat, the location and therefore the meaning of a mark or a series of marks may be misinterpreted possibly causing unacceptable errors, including misreading the form.

### SUMMARY OF THE INVENTION

The present invention is directed toward creating and reading stereoscopic views of the same scene, for example, the scene may be a form. The parallax ability of the present invention allows a determination that the example form is flat or not, or a determination that the form is not reliably readable. Raw or unprocessed digital data from the stereoscopic views of the same scene may be processed to convert the raw digital data into digital data that would have been gathered if the form were flat. The present invention may provide a virtual flat form from the raw data of a bent form.

The present subject matter includes previously stored models of known forms, in which the location information and characteristics of boundaries, logos, registration and alignment marks and any other relevant areas of interest on the form are stored in a computer system. The characteristics may include, for example, the center of mass of a mark, the radius of gyration of the mark, the number of pixels in the mark, and the shape of the mark. In addition, the characteristics may include the length, thickness and shape of lines, logos, registration marks or other such artifacts. The type of form may be indicated by an agent, or one or more identifying marks may be read wherein the processing system knows the type of form being processed.

It is presumed that the two views of captured digital data and the model have been registered to each other. That may be accomplished by presenting a flat target as the scene for both optical paths. Specific locations on the target may indicate the origin for an X, Y coordinate system that applies to both stereoscopic views and the model for that form.

The location of a mark is defined as the center of mass (COM) of the mark, where the center of mass is: COMx=(ΣXpixels)/(# of X pixels); COMy=(ΣYpixels)/(# of Y pixels). The radius of gyration is Rgyr=(Σmr²/mass)^{1/2}. Here mass is the number of pixels in the mark and m is the mass of one pixel, here assumed to be 1. The Rgyr is independent of orientation. Other characteristics may include mass alone, shape, and other geometric moments may be used.

Illustratively, two stereoscopic optical images of a form are captured and referred to as “captured optical images.” Since the images are taken from two different views, parallax techniques may be used in processing these images. Each view may be received by separate photo-sensitive surfaces (within a camera, etc.) that may be separate areas of one photo-sensitive surface or that may be two photo-sensitive surfaces, but both within one camera. The two captured optical images are digitized forming “captured digital images” that are registered and stored in a memory wherein the captured digital images may be compared to each other and to the stored model. The digitalization may occur in the camera electronics or in the processor. An application in a computer system coordinates the digitization, registration, storing, comparing, and thresholding of acceptable differences (discussed below) to determine to further process or reject the form. The further processing may include reading all the relevant, including man-made marks on the form and forming a virtual flat form by correcting the differences and then reading all the relevant marks on the form. The information of the marks may then be sent to a central controller that may authorize a payout to the form holder or otherwise process the information.

It is noted that optical filters and analog-type processing may be accomplished in embodiments of the present invention, although they are not discussed hereinafter.

The processing of the two captured digital images may entail comparing marks on the images to each other and to marks on the model of the form. Discrepancies will become readily apparent. For example, if the two stereoscopic views are properly registered and aligned with each other, and a straight line segment at a known location is on the form, that straight line segment on each of the captured digital images will be congruent (within acceptable tolerances, see below) to each other if the form is flat. The two captured digital images and the model will all have marks with identical characteristics of location (COM), size, Rgyr, line length, line thickness, etc., if the form is flat.

If the form is not flat, in the above example, the two captured digital images of a straight line (or any other such mark or artifact), when compared, will not be congruent with each other or with the model of the straight line. Illustratively, if a form is bent upward, a straight line traversing the bend will not be congruent on the two captured digitized images of the line or to the model of the straight line. Moreover, a mark that is raised on the bent portion of a form will have a different location in each of the captured images and both of these locations will be different from the location on the model (flat) form. The mark will be of a different size compared to each of the captured images and to the stored model.

If enough known marks are distributed on the form, parallax-type corrections may be applied to the entire form, or conversely, the parallax-type correction may indicate that the form should be rejected as not flat enough. The granularity (the closeness of the known marks) may allow corrections to the entire captured images of the form and, thus, the entire form may be read and processed. Parallax correction refers to comparisons of locations in the two captured images to each of and to the model. The comparisons refer to geometric, trigonometric calculations from the known locations and characteristics of the marks and the measured locations and characteristics. In one embodiment, if the correction calculations indicate that the raised portion of a form exceeds about 0.5 inches (heuristically determined), the form should be rejected.

The model includes locations and characteristics of marks such as lines, symbols, logos, alignment, registration and/or other printed information on the form. The system may compare the model to the captured digital images and detect differences. For example, when a known single straight line on a form is captured as something other than a single straight line, the system may determine that the form is not flat and it may be rejected. For example, the orientation of the straight line on a bent form with respect to the cameras may capture the line as straight but with differing lengths compared to the straight line in the model form or as a bent line. Such differences are indications that the form is not flat.

The differences, however, may be used to indicate that the form is flat. For example, thresholds may be developed and applied to the differences that might determine that the example form is flat enough to be further processed.

The differences between and among the two captured digital images and the stored model digital image may allow correction for the non-flatness of the form wherein a virtual flat form results. Projection algorithms have been developed that will correct for a known form that is bent. For example, Mercator Projections and similar projections are known to those skilled in the art.

Herein, if the thresholds are “met,” the differences may be judged to be too great and the form may be rejected. If the thresholds are not met, the differences are judged to be small enough to allow further processing of the form. The thresholds may be applied after projection processes have been applied. Illustratively, known marks distributed over the entire surface of the form may be used to determine that the entire surface of interest on a form is flat enough to process any other marks on the example form. The surface of interest includes any location on the form where known or man-made marks may exist to convey relevant information of the form type.

### BRIEF DESCRIPTION OF THE DRAWINGS

The invention description below refers to the accompanying drawings, of which:

FIG. 1 is block diagram of a system embodying the present invention;

FIG. 2 is a drawing of an alternative optic system embodiment of the present invention; and

FIGS. 3A and 3B illustrate light ray tracing details and image maps from a flat and a bent or folded form.

### DETAILED DESCRIPTION OF AN ILLUSTRATIVE EMBODIMENT

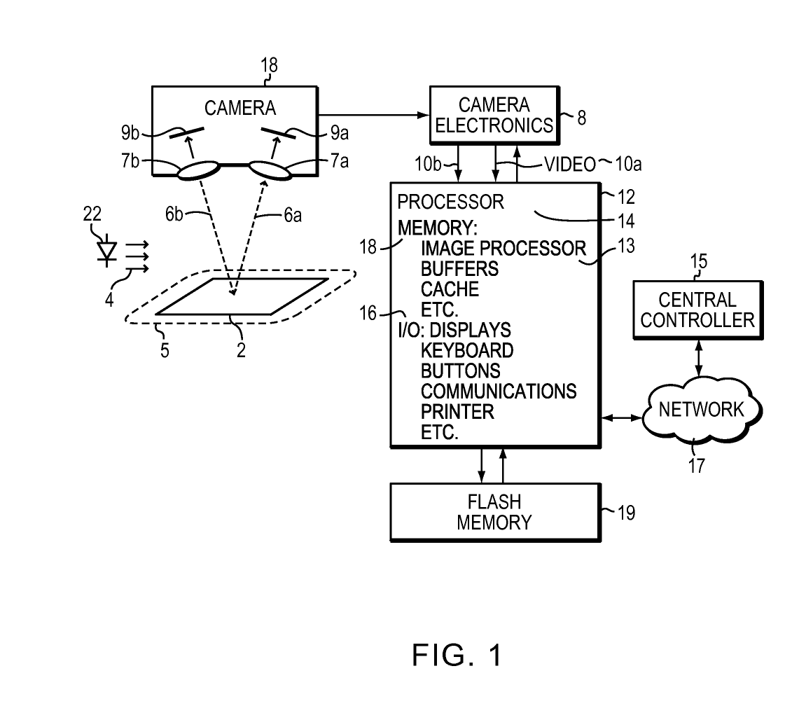

FIG. 1 illustrates an exemplary system where a form 2 is illuminated by an LED light source 22 and reflects light 6a and 6b from the form 2 to a camera 18. Two lenses 7a and 7b in the camera 18 direct the reflected light 6a and 6b from the same scene (from form 2) onto two photo-sensitive surfaces areas 9a and 9b from two different angles. Preferably, areas 9a and 9b are part of the same photo-sensitive surface, but two separate surfaces may be employed. Note that the lenses 7a and 7b form an optical angle between 6a and 6b that effects the stereoscopic views of the form 2. These views provide depth perceptions and are the views upon which parallax calculations may be performed.

The following presumes that the form type is known (an agent may so indicate), and that the two areas 9a and 9b have been registered with respect to each other and to a model of the form.

Note that the lenses 7a and 7b and the photo-sensitive surface areas 9a and 9b are representative and may be quite different in practice. For example, one or no lenses may be used, but alternatively, optic modules with lenses and mirrors may also be used, and photo-sensitive surface areas 9a and 9b may, as mentioned above, be separate surfaces within one camera, as well as different areas on a single surface.

The form 2 is located on a platen 5 that is positioned below the camera 18. Two captured optical images of the same scene are formed on the photo-sensitive surface areas 9a and 9b that may be downloaded (e.g., scanned, read-out) by electronics 8 to produce video signals 10a and 10b for each surface 9a and 9b, respectively. The video signals 10a and 10b are digitized and stored as pixels (or pixel data) of two captured digital images in memory 18 on a computer system 12.

The computer system 12 includes a processor 14 that operates on the pixels, the memory 18 and I/O drivers 16 that handle, at least, displays, keyboards, buttons, and communications. The computer system 12 may be connected to a network 17 that communicates with a central controller 15.

Memory 18 may include one or more image buffers, other buffers, cache, etc. An operating system and software applications may be stored in memory 18. An image processing application 13, discussed below, processes the image data for both of the stereoscopic captured digitized images. Removable flash memory 19, as preferred, may contain the application programs wherein removing the flash for software security leaves no application programs in the computer system 12.

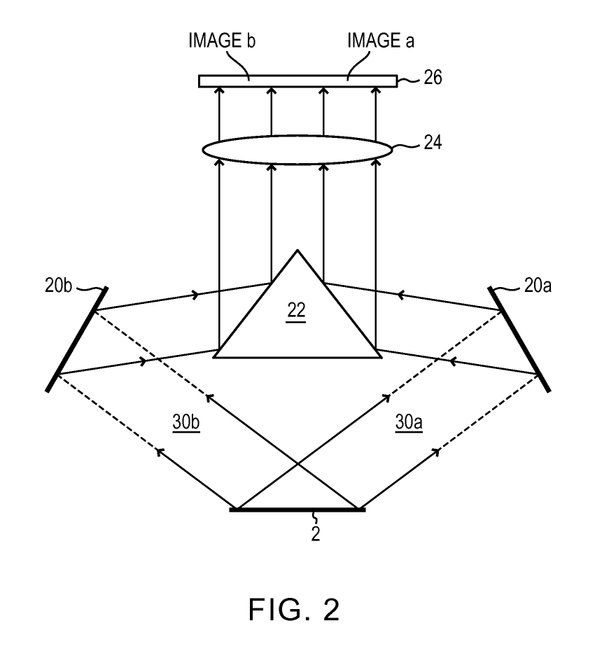

FIG. 2 illustrates another optics implementation that may provide a stereoscopic view of the example form 2. In accord with this implementation, the ray tracings in FIG. 2 are representative. Here, light 30a and 30b is reflected from the form 2 onto two mirrors 20a and 20b, and is in-turn reflected by a mirrored prism 22. The light from the mirrored prism 22 is directed via an optics system (shown as a single lens) 24 onto a photo-sensitive surface 26. In this case, the light from example form 2 is finally focused on the photo-sensitive surface as “IMAGE a” and “IMAGE b” that are each arranged to fall on about one half of the surface area of the photo-sensitive surface 26.

Although the photo-sensitive surface 26 is shown as a single surface, the images are directed onto separate sections that can be addressed and downloaded independently. The captured optical image data on the photo-sensitive surfaces represents the light intensity striking the photo-sensitive surface. As described above, the camera electronics 8 reads out the image intensity data from the photo-sensitive surface 26. The video signals 10a and 10b are downloaded to the processing system 12 where it is digitized and processed.

Since the same scene is input to the photo-sensitive surfaces, in order to compare the two views of the same scene, as mentioned above, the corresponding locations on each photo-sensitive surface must be registered with each other. Known registration marks may be recognized and located on each image such that the “IMAGE a” pixels and the “IMAGE b” pixels correspond directly to each other. That is, all the corresponding locations within each image can be directly overlaid and match each other within each captured digital image. Typically, the captured digital images and the model are registered on an X,Y plane coordinate system, but other systems may be used.

Parallax effects are well-known in the art and represent one method of measuring distances, for example, astronomical distances to other heavenly bodies. The angle to a heavenly body from two different locations may be compared and the difference in the measured angle is a function of the distance to that heavenly body. Parallax calculation, however, also allows, as in the present application, the ability to detect a form that is bent, and then project the marks on a bent form to locations and sizes as if the marks were on a flat form—a virtual flat form.

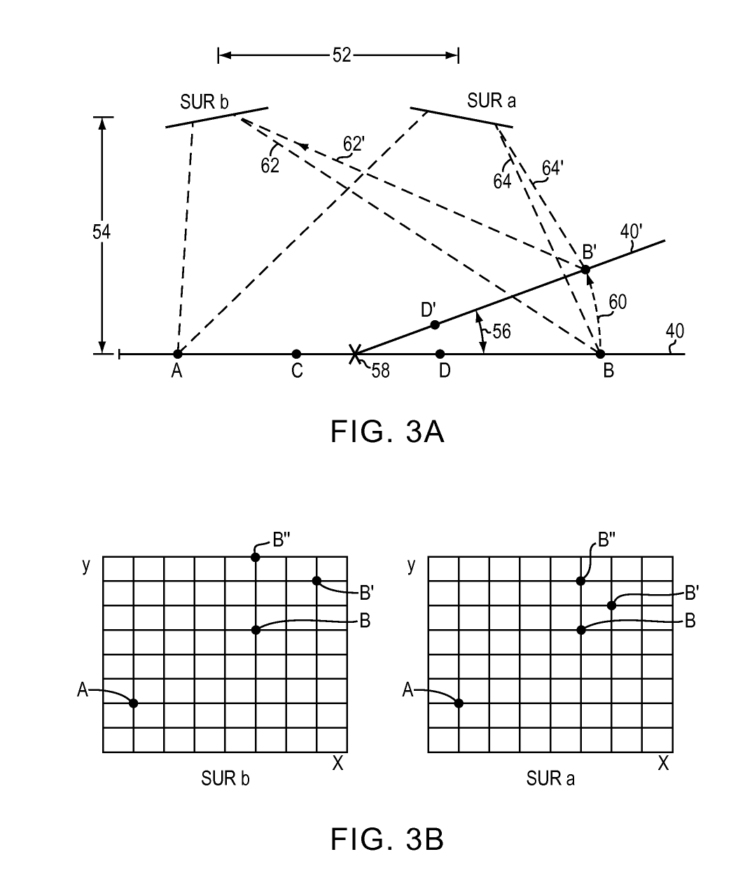

FIG. 3A illustrates an error on a bent form 40 (40′) that is correctable via parallax calculations. Here, two portions of the same photo-sensitive surface, SURa and SURb, view the same image—the flat form 40. The surfaces, SURa and SURb, represent two sections of the same photo-sensitive surface. Optical lenses, filters, prisms, mirrors, an aperture, not shown, may be positioned between the form 40 and the photo-sensitive surfaces, SURa and SURb. FIG. 3B represents two dimensional, X,Y, maps of the surfaces SURa and SURb, respectively. Corresponding X,Y locations on the two surfaces SURa and SURb have already been registered so that points on the form 40 (and bent form 40′) will be at the same x-y locations on both coordinate systems for SURa and SURb. Note that the SURa and SURb are maps representing the photo-sensitive surface 26, but the maps exist in the memory 18, and operations on the maps are accomplished in the computer system 12. Here, the images of points A and B on the form 40 are shown at the same relative locations on the x-y map representations of FIG. 3B since the form 40 is flat. The A and B point locations will also be found at the same relative X,Y map coordinates for the known stored model for the form 40.

Form 40′ reflects form 40 with a bend at location 58 through the angle 56. The point B rotates upwards 60 to location B′. On the maps of FIG. 3B, the point B moves to the respective locations marked B′. In this example, the direction in each surface of FIG. 3B is co-axial with the imaginary lines from A to B on each surface. If the axis of rotation at point 58 is normal to the paper and to the orientations of SURb and SURa, the movements on each map will be co-axial with the imaginary lines from A to B.

Note that the distances of the movement from B to B′ on each map are not of the same length. This is obvious from inspection of the ray tracings of FIG. 3A. The ray 62 from B to SURa and the ray 62′ from B′ form a bigger angle than the corresponding rays, 64 and 64′ to SURa. The larger the angle, the longer will be the distances on the maps of FIG. 3B.

But the movement from B to B′ in each surface of FIG. 3B need not be co-axial with the imaginary lines from A to B on each surface. This may be explained if the line AB is not normal to the fold at 58, or that the fold at 58 is not perpendicular to the page bearing FIGS. 3A and 3B, or both. In this case when the form is bent, 40′, point B moves relatively to points B″ in both maps. Again, the distances are different and here the points B″ are not co-axial in either map with the lines defined by the points A and B.

The locations, characteristics and meanings of marks on the model for form 40 are known to the processor 12. The marks A and B may have parameters (shapes, size, etc. as mentioned above) that are known to the processor 12. The processor 12 may process the captured digital images and recognize the marks A and B, and know where they should be located on SURa and SURb. When the processor finds the location of the mark B to be different on SURa and SURb, the processor may than apply a correction factor that moves the locations from B′ of B″ to B on each map. This process may be expanded by locating other known recognizable marks on the form, like C and D, where C is at its model location but where D is at D′ due to the fold at 58. With enough marks distributed over the entire surface of the form 40, correction factors may be developed and applied for the entire surface of the form 40. The result is a virtual flat form where the marks on the form can be interpreted for meanings.

Known marks on the form may be used to calculate corrected locations for other known marks on the form. Difference errors may be calculated for these known marks, and, if there are enough distributed over the surface of the form, errors may be calculated for areas over the entire surface of the form.

For example, in FIG. 3A, the distances 52 between the photo-sensitive surfaces, SURa and SURb, and the height 54 and the distance from A to C to D and B from the model are all known. Knowing these distances, the bend in the form at 58 may be corrected wherein the true locations on of A, C, D and B on the maps can be calculated from the captured image location D′ and B′. Such mapping and correcting projections using geometry, trigonometry, known mapping projections (e.g., Mercator projections) etc., are well within the skill of those practitioners in the field. Of course, if the form 40 is severely curled, crumpled, bent and/or rolled, the known marks on the form may be found or threshold may be met wherein the form is rejected back to the agent or user to be read by other means.

Thresholds may be developed heuristically and if the calculated errors fall within thresholds, all the marks, including man-made marks, on the form may be read and processed. In one application, a threshold of 0.5 inches of a rise of a mark from a virtual flat form to the actual form may be applied. For example, from the FIG. 3A, if the vertical distance of point B′ above the plane 40 of a virtual flat form is calculated to be more than 0.5 inches the form may be rejected. The calculation is direct since the distances 52, 54, A to B, and the lengths of rays 62 and 62′ are known.

On FIG. 3A, the points A, C, D and B are shown as points, but they may be marks with significant size and shape. If a mark is physically raised closer to the camera (at the same perspective), the mark will subtend a large angle and the captured image of the mark will be larger. The COM, the Radius of Gyration and size of the mark (the number of pixels that comprise the mark) may all be known. Illustratively, if the size is known, but the actual captured image shows the size to be ±10% of the true size, the form may be rejected. Heuristically, other such thresholds may be developed.

The corrections may include, but are not limited to, location and/or parameters of the mark including location, orientation, size or scale, line thickness, degree of congruency (how much of the mark is congruent among the two captured images and the model image), etc.

It should be understood that above-described embodiments are being presented herein as examples and that many variations and alternatives thereof are possible. Accordingly, the present invention should be viewed broadly as being defined only as set forth in the hereinafter appended claims.

What is claimed is:

1. A system for taking stereoscopic views of an example of a known form, the system comprising:
a camera with at least one optical opening encompassing two distinct optical paths, each path accepting light reflected from the same scene on the form;
a photo-sensitive area defining two separate photo-sensitive surfaces, wherein each optical path leads to one of the two separate photo-sensitive surfaces and a captured optical image of the same scene is formed on each of the two separate photo-sensitive surfaces;
a digitizer that converts the two captured optical images into two captured digital images;
a memory that receives and stores the two captured digital images, wherein the memory contains a model of the known form and the locations of printed marks on the model of the known form; and
a comparator that compares the mark at a known location on the model to the corresponding marks in the two captured digital images, wherein if the comparison is accepted, the digital images are further processed.

2. The system of claim 1 wherein the captured digital images are registered to each other and each is projected on to X,Y coordinate system maps.

3. The system of claim 1 wherein the model includes characteristics of the printed marks on the model form.

4. The system of claim 1 further comprising a computer system application that compares the corresponding marks and locations in each of the captured digital images to each other, and wherein, if there are differences, the captured digital images are further processed.

5. The system of claim 1 further comprising a computer system application that applies thresholds to the differences, if any, wherein if the thresholds are not met the captured digital images may be further processed.

6. The system of claim 1 further comprising a computer system that comprises the digitizer, the memory and the comparator, and a computer system application that coordinates the digitizing, the memory contents and the comparator operations.

7. The system of claim 1 further comprising a computer system having a computer application that corrects differences found among the two captured digital images and the model to provide a virtual flat digital image of the known form.

8. The system of claim 1 wherein the comparison are made of the location and characteristics of marks.

9. The system of claim 1 wherein the comparator compares many marks distributed over the surface of the form.

10. A method for processing forms comprising the steps of:
storing a model, a digital image, of a form, and example of which is to be processed;
accepting light reflected from two different angles of the same scene on the form being processed, the reflected light defining two optical images of the scene;
directing the accepted light onto two separate photo-sensitive surfaces;
converting the two captured optical images into two captured digital images; and
comparing a mark at a known location on the model to a corresponding mark in the two captured digital images, wherein if the comparison is acceptable, the captured digital images are available for further processing.

11. The method of claim 10 further comprising the steps of:
projecting the captured digital images onto X,Y coordinate systems, wherein the captured digital images are registered with each other.

12. The method of claim 10 further comprising the step of:
establishing and applying thresholds to the differences, if any, wherein if the thresholds are not met the form may be further processed.

13. The method of claim 10 further comprising the steps of correcting for the differences in the captured digital images, and, therefrom, forming a virtual flat digital image of the known form.

14. The method of claim 10 wherein the step of comparing also includes comparing locations and characteristics of the mark.

15. The method of claim 10 further comprising the step of comparing many marks distributed over the model and the captured digital images.
